(19) United States
(12) Patent Application Publication
(10) Pub. No.: US 2003/0063847 A1
(43) Pub. Date: Apr. 3, 2003

(54) Deep fiber network architecture

(76) Inventor: George H. BuAbbud, Southlake, TX (US)

Correspondence Address: F. Drexel Feeling, Esq., JONES, DAY, REAVIS & POGUE, North Point, 901 Lakeside Avenue, Cleveland, OH, 44114, US

(21) Appl. No.: 10/199,549

(22) Filed: Jul. 19, 2002

Related U.S. Application Data
(60) Provisional application No. 60/306,926, filed on Jul. 20, 2001.

(51) Int. Cl. G02B 6/28; H04B 10/24

(52) U.S. Cl. 385/24; 359/109

(57) ABSTRACT

A communication system for transmitting video signals to a subscriber using optical fibers, for providing bi-directional telephone services for a subscriber using optical fibers, and for providing high-speed data services to a subscriber via a cable modem using optical fibers is provided. The communication system comprises a first optical fiber for transporting video programming at a first wavelength from a video-programming source to a network node. The system further comprises a second optical fiber for transporting video programming at a second wavelength from the network node to an optical node device and for transporting bi-directional telephone signals between the optical node device and the network node at a third wavelength in a downstream direction and a fourth wavelength in an upstream direction. The system further comprises a signal combining device located at the network node that combines cable modem (CM) signals from a cable modem transmission system (CMTS) located at the network node with the video programming prior to the transportation of the video programming on the second optical fiber. In addition the system comprises a high bandwidth bi-directional communication path between the CMTS and a public network.

### CROSS REFERENCE TO RELATED APPLICATIONS

This application claims priority from and is related to U.S. Provisional Application No. 60/306,926 entitled “DFHFC Network Architecture,” which was filed on Jul. 20, 2001. The entire disclosure of U.S. Provisional Application No. 60/306,926 is hereby incorporated into the present application by reference.

### BACKGROUND OF THE INVENTION

1. Technical Field

The present invention generally relates to methods and apparatus for carrying on communications over optical fibers. More specifically, the invention is directed to methods and apparatus to provide bi-directional telephonic communication and bi-directional digital data transmission such as cable modem services and transmitting multicast TV.

2. Description of the Related Art

The communications industry is using more and more optical fibers in lieu of copper wire. Optical fibers have an extremely high bandwidth thereby allowing the transmission of significantly more information than can be carried by a copper wire transmission line such as twisted pairs or coaxial cable.

Of course, modem telephone systems require bi-directional communications where each station or user on a communication channel can both transmit and receive. This is true, of course, whether using electrical wiring or optical fibers as the transmission medium. Early telephone communication systems solved this need by simply providing separate copper wires for carrying the communications in each direction, and this approach is still used in older installations where telephony is the only required service. It is also often used even where digital transmission service is demanded as the signals get closer to the end users. Although twisted pairs and coaxial cables are used in homes and distribution terminals close to the home end user, some modern telecommunication systems now use microwave and optic fibers as transmission mediums.

Because of extremely high bandwidths available for use by an optical fiber, a single fiber is quite capable of carrying a great number of communications in both directions. One technique of optical transmission is WDM (wavelength divisional multiplexing) and uses different wavelengths for each direction of travel.

Another area of rapidly growing technology is providing unidirectional TV signals by cable to a multiplicity of subscribers or users (multicast). In the past, such signals were and still are typically transmitted by the use of coaxial cables (e.g. cable TV). However, the use of optical fibers for transmission allows broad band transmission to a large numbers of customers and, since substantially all of the transmission of TV signals is one way (i.e. unidirectional), if a single optical fiber were used solely for the TV signals there would be almost no use of the selected wavelength of light for carrying return signal, which are typically control or information signals.

### SUMMARY OF THE INVENTION

A communication system for transmitting video signals to a subscriber using optical fibers, for providing bi-directional telephone services for a subscriber using optical fibers, and for providing high-speed data services to a subscriber via a cable modem using optical fibers is provided. The communication system comprises a first optical fiber for transporting video programming at a first wavelength from a video-programming source to a network node. The system further comprises a second optical fiber for transporting video programming at a second wavelength from the network node to an optical node device and for transporting bi-directional telephone signals between the optical node device and the network node at a third wavelength in a downstream direction and a fourth wavelength in an upstream direction. The system further comprises a signal combining device located at the network node that combines cable modem (CM) signals from a cable modem transmission system (CMTS) located at the network node with the video programming prior to the transportation of the video programming on the second optical fiber. In addition the system comprises a high bandwidth bi-directional communication path between the CMTS and a public network.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 is a block diagram of an exemplary HFC system;

FIG. 2 is a more detailed diagram of a HFC system that shows an exemplary head end and exemplary HDT;

FIG. 3 is a schematic diagram of a first alternative embodiment of a communication system comprising a head end and a HDT;

FIG. 4 is a schematic diagram of a second alternative embodiment of a communication system comprising a head end and a HDT;

FIG. 5 is a schematic diagram of a third alternative embodiment of a communication system comprising a head end and a HDT; and

FIG. 6 is a schematic diagram of a fourth alternative embodiment of a communication system comprising a head end and a HDT.

### DETAILED DESCRIPTION

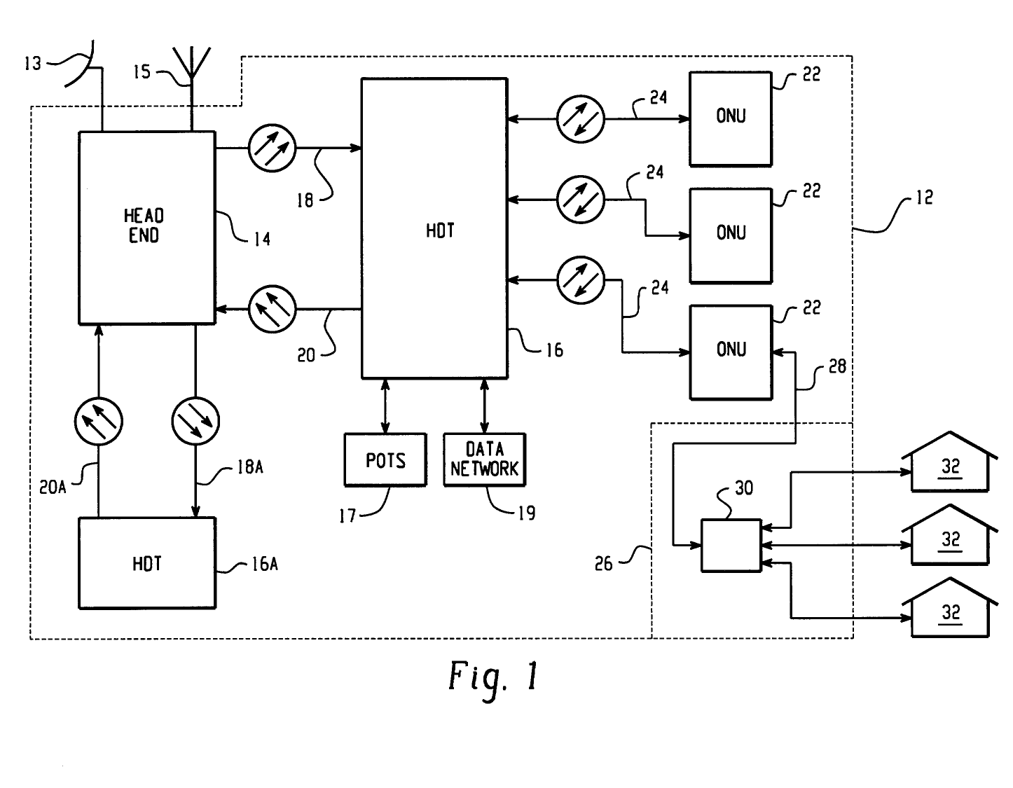

Shown in FIG. 1 is a preferred embodiment of a fiber-to-the-curb (FTTC) communication system 10 for delivering residential and/or business telecommunication services over a hybrid fiber-coaxial (HFC) distribution network 12. This embodiment takes partial advantage of the existing telephone and coaxial TV distribution systems 26 while also using a single optical fiber 24 for part of the bi-directional telephone transmission (POTS) as well as part of the transmission path between a video source location 14 and a building or home 32. The exemplary communication system 10 comprises a cable head-end 14, one or more network nodes such as host digital terminals or points-of-presence 16, optical fibers 18, 20 that provide communication paths between the host digital terminal and the cable head-end, a plurality of optical node devices 22, optical fibers 24 that provide communication paths between the optical node devices 22 and the host digital terminal 16, and coaxial distribution plants 26 that comprise coaxial and other copper cables 28 and splitters/amplifiers 30 that are used to distribute signals to homes and/or businesses 32 that subscribe to services provided by the communication system 10. It should be noted that, although the following discussion is in terms of a single direct path for the coaxial and optical fiber cable between two locations 14 and 32, in actuality there will be a significant amount of multiplexing and de-multiplexing such that many subscribers or customers may be serviced by the single optical fiber and other multiplexed cables. It should also be noted that there might also be several amplification stations located at various locations in the distribution path. Further, as is shown, in addition to the optical fibers 18 and 20 traveling between the head end 14 and the HDT 16, there will be other optical fibers as indicated by optical fibers 18A and 20A that extend between the head end 14 and other HDTs 16A.

The cable head-end 14 provides the communication system 10 with video programming, such as television (TV) programming or video on demand, that is to be passed on to subscribers and may also provide cable modem services to subscribers. In distributing cable television services, the head-end 16 preferably includes a satellite dish antenna 13 and/or a radio frequency (RF) antenna 15 for receiving incoming programming. The head-end 16 may also include equipment to play videotapes and/or to originate live programming that is passed on to subscribers. Most signals are sent downstream to the subscriber, but some signals are received upstream such as when a customer requests a pay-per-view program. When a cable company provides Internet access to subscribers, the head-end often includes the computer system and databases needed to provide Internet access. A Cable Modem Termination System (CMTS) is typically located at the head end, which sends and receives digital cable modem signals on a cable network and is necessary for providing Internet services to cable subscribers.

A cable modem termination system (CMTS) is a component that exchanges digital signals with cable modems on a cable network. When a CMTS receives signals from a cable modem, it converts these signals into Internet Protocol (IP) packets, which are then sent to an IP router for transmission across the Internet. When a CMTS sends signals to a cable modem, it modulates the downstream signals for transmission across the cable to the cable modem. All cable modems can receive from and send signals to the CMTS but not to other cable modems on the line.

In the exemplary communication system 10, the head end 14 passes programming and cable modem signals in the downstream direction to one or more host digital terminals (HDTs) 16 via an optical fiber(s) 18. The head end 14 receives cable modem signals and other signals in the upstream direction from the HDT(s) 16 via an optical fiber(s) 20. In addition to having a connection to the head end 14 for receiving programming and exchanging cable modem signals, the HDT also preferably includes a connection to the plain old telephone service (POTS) 17 and optionally a connection to a data network 19. The HDT 16 is preferably coupled to a plurality of optical node devices 22 such as optical network units (ONUs) 22 via optical fibers 24 wherein a single fiber couples a single ONU 22 to a HDT 16. Signals collected by the HDT 16 are collected and multiplexed onto a single optical fiber to be transmitted to an ONU 22. The HDT 16 also receives optical signals from the ONUs 22, demultiplexes the signals and transmit the signals to their proper destination, i.e., the head end 14, the POTS system 17, or the data network 19.

Exemplary HFC Network Architecture

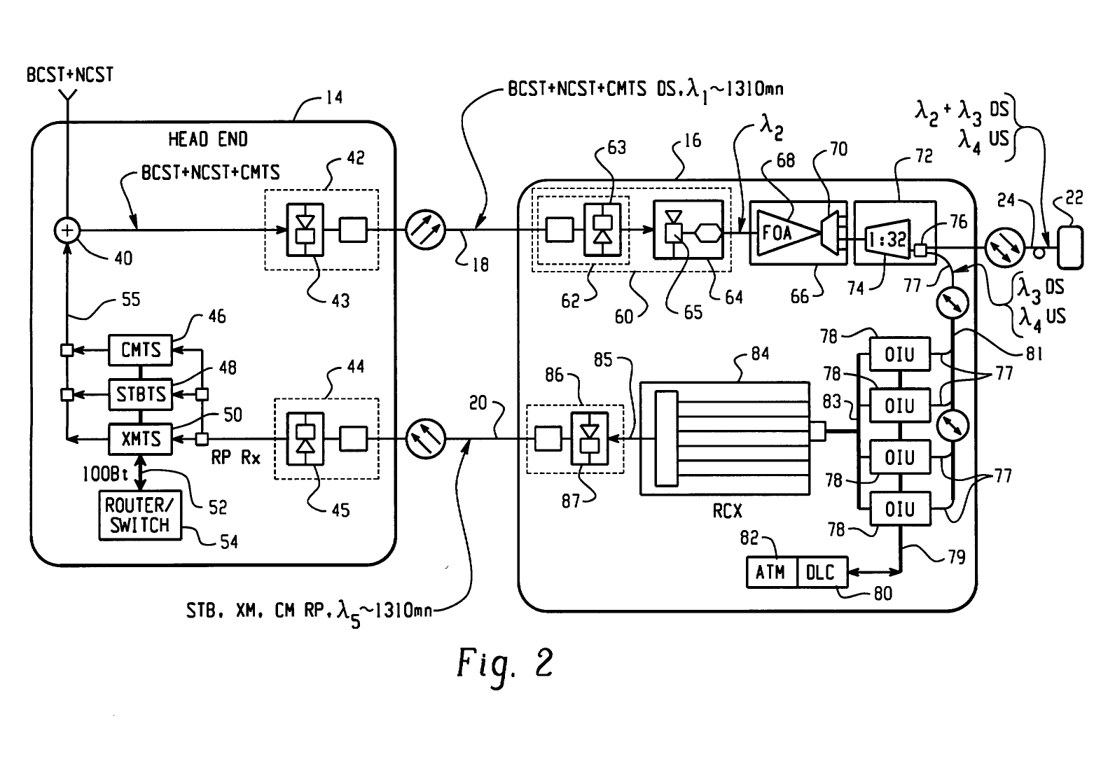

Referring now to FIG. 2, shown in more detail is an exemplary portion of a HFC network that includes a head end 14 and a network node 16. The head end shown is preferably located at a central office (CO) and the network node 16 is preferably a HDT or POP located at a CO. The head end 14 preferably includes an electrical signal combining device 40 such as an adder, an electrical-to-optical (E/O) converter device 42, an optical-to-electrical (O/E) converter device 44, a cable modem transmission system (CMTS) 46, a set top box transmission system (STBTS) 48, an XMTS 50, and a communication link 52 for connection to a router/switch 54 that provides communication paths to a data communication network. The head end 14 and the HDT 16 cooperate to send signals downstream (DS) from the head end 14 to the ONU 22 (and ultimately to a subscriber's home or business location). The head end 14 and the HDT 16 also cooperate to send signals (that originate from a subscriber's home or business location) upstream (US) on a return path (RP) from the ONU 22 to the HDT 16 and finally to the head end.

In the DS path in the head end 14, the electrical signal-combining device 40 receives electrical signals that are to be transmitted to subscribers and combines them in the frequency domain. Preferably the electrical signal combining device 40 receives broadcast cable signal transmissions (BCST) and narrow-cast cable signal transmissions (NCST), such as pay-per-view stations, combines these cable signals with cable modem transmission signals from the CMTS 46, and forwards the combined signals to the E/O converter device 42. The E/O converter device 42 preferably includes a laser diode 43 that is used to convert the combined electrical signals to a light wave signal at a wavelength λ₁ that can be transported downstream over the optical fiber 18 to the HDT 16. In the embodiment shown in FIG. 2, the signals are transmitted over the optical fiber 18 at a wavelength λ₁ of in the 1310 nm (nano-meters) window.

In the US path in the head end 14, the O/E converter device 44 receives signals at a wavelength λ₅ from the HDT 16 via the optical fiber 20. In the embodiment shown in FIG. 2, the RP signals are transmitted over the optical fiber 20 at a wavelength λ₅ of in the 1310 nm window. The RP signals preferably include set top box (STB) signals, XM signals, and cable modem (CM) signals. The O/E converter device 44, which preferably includes a photo diode 45, converts the light wave signal at the wavelength λ₅ to electrical signals. The converted electrical signals are forwarded to the appropriate termination system, the CMTS 46, the STBTS 48, or the XMTS 50. The termination systems 51 preferably have a high bandwidth link 52 to a Router/Switch 54 for exchanging data with a public network such as an IP network. The high bandwidth link 52 in the example of FIG. 2 is a 100 Bt Ethernet link, however, other communication links could be used such as a Gigabit Ethernet link and others. The termination systems 51 also preferably have a communication path 55 to the electrical signal-combining device 40 for sending signals downstream over the DS path.

In the DS path in the HDT 16, a signal modification device 60 is preferably provided that comprises an O/E converter 62 and an E/O converter 64. The O/E converter 62 preferably includes a photo diode 63 for converting optical signals received from the head end 16 via the optical fiber 18 to electrical signals. The E/O converter 64 preferably includes a laser diode 65 for converting electrical signals to optical signals at a wavelength λ₂ where the wavelength λ₂ may or may not be equal to the wavelength λ₁. In the embodiment shown, the wavelength λ₂ is preferably in the 1550 nm window. The signal modification device 60 is not required for the DS path in this embodiment but is preferably used to allow for local signals to be inserted into the DS path to an ONU. After producing optical signals at the wavelength λ₂, the optical signals are forwarded to a fiber optic amplifier/splitter stage 66 that preferably includes a fiber optical amplifier (FOA) 68 and a splitter 70. The fiber optic amplifier/splitter stage 66 amplifies the optical signals at wavelength λ₂, splits the amplified optical signals into a plurality of split optical signals and forwards each split optical signal to a separate splitter wavelength division multiplexer cross-connect (SWX) 72. In the embodiment shown the splitter 70 is a 1:4 splitter, however, other splitters, such as a 1:8 splitter, could be used.

Shown in FIG. 2 is one such SWX 72, however, a plurality of SWXs preferably is provided. The SWX 72 preferably includes a splitter 74 that has a plurality of outputs (32 are shown in this embodiment). Each output of the splitter 74 is paired with a wavelength division multiplexer (WDM) stage 76. Shown in FIG. 2 is one such output/WDM pair, however, a plurality of output/WDM pairs is preferably provided. The WDM stage 76 combines the optical signals at wavelength λ₂ that are received from the splitter 74 with optical signals at wavelength λ₃ that are generated by one of the optical interface units (OIUs) 78 and forwards the combined multi-wavelength signals to an ONU 22 via an optical fiber 24. The OIUs 78 preferably have a public network communication path 79 to a public network via, for example, a digital loop carrier (DLC) 80 and an ATM network 82 for providing POTS (plain old telephone services) and/or data, such as DSL services, to subscribers. Consequently the OIUs 78, via an optical signal on a single fiber 77, can forward POTS and data signals from the public network to subscribers from the group of fibers 81. In the embodiment shown, the wavelength λ₃ is preferably in the 1310 nm window. Each WDM stage 76 preferably exchanges signals with a single OIU 78 via an optical fiber 77 and exchanges signals with a single ONU 22 via an optical fiber 24. Consequently, preferably there is a single WDM stage 76 corresponding to each OIU 78, and each WDM/OIU pair can exchange signals with a single ONU 22.

In the US path from the ONU 22, optical signals at a wavelength λ₄ are transmitted from the ONU 22 to the associated OIU 78 via a single optical fiber 24 and a single optical fiber 77. Each ONU 22 communicates with a single OIU 78. In the embodiment shown, the wavelength λ₄ is approximately equal to the wavelength λ₃, which is preferably in the 1310 nm window. The light signals at 1310 nm are able to travel in both directions on the single fiber optic cable 24 and single fiber optic cable 77. Each OIU 78 receives optical signals, converts the optical signals to electrical signals, and forwards the electrical signals to the appropriate destination. For example, POTS signals are transmitted to the public network via the public network communication path 79, the DLC 80, and the ATM network 82. STB, XM, and CM signals are forwarded by the OIUs via a plurality of copper wires 83 to the return path combiner cross-connect (RCX) 84. There is a separate copper wire 83 for each OIU 78 that electrically couples that OIU 78 to the RCX 84. The RCX 84 multiplexes the signals coming over the plurality of copper wires 78 onto a single line 85. The RCX 84 combines multiple signals from multiple OIUs 78 into one signal on one cable 85. The multiplexed signals are provided to a return path (RP) transmitter 86 that includes a laser diode 87 for converter the RP electrical signals to RP optical signals for transmission over optical fiber 20 to the head end 14. In the embodiment shown, the RP optical signals are at a wavelength λ₅ wherein the wavelength λ₅ is preferably in the 1310 nm window.

First Alternative Exemplary Embodiment

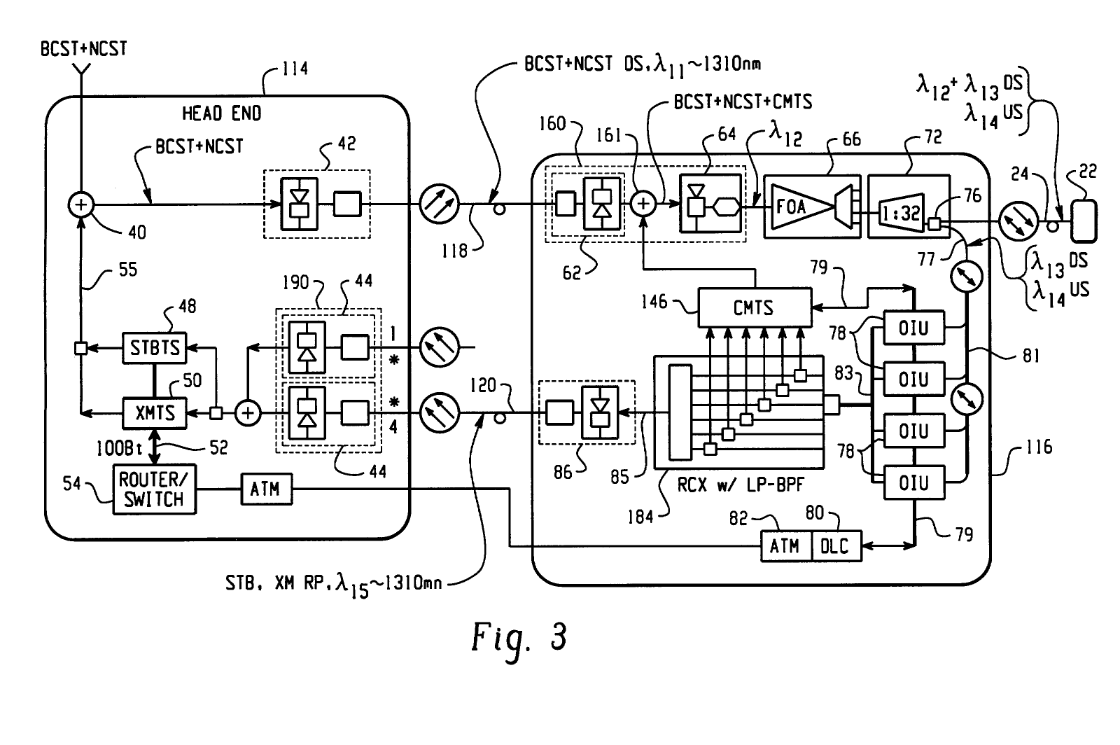

Referring now to FIG. 3, shown in a first alternative exemplary embodiment of a HFC network architecture that can provide increased cable modem bandwidth over the embodiment illustrated in FIG. 2. This embodiment also allows for greater aggregation of the return path signals, such as CM and STB signals, at the CMTS. Greater aggregation can be achieved because by moving the CMTS to a network node such as a HDT, degradation of the noise-to-power-ratio (NPR) that the signals would encounter at the input of the CMTS if the signals had to go through the path to the head end is eliminated. This embodiment comprises a head end 116 and a network node such as a HDT 118. The head end 116 shown is similar to the head end 16 of FIG. 2 and has many elements that are comparable to the elements of the head end 16. The HDT 118 is similar to the HDT 18 of FIG. 2 and has many elements that are comparable to the elements of the HDT 18. The head end 116 and HDT 118, however, differ in a few ways.

To increase cable modem bandwidth and to decrease NPR degredation, the cable modem transmission system (CMTS) 146 is located in the HDT 118. Therefore each of the HDTs 118 connected to the head end 116 has its own CMTS 146 instead of sharing a common CMTS 146. Also, the cable modem bandwidth is not limited by the bandwidth limits for a particular wavelength of light.

In the DS path in the head end 114, the electrical signal combining device 40 preferably receives broadcast cable signal transmissions (BCST) and/or narrow-cast cable signal transmissions (NCST), such as pay-per-view stations, combines these cable signals, and forwards the combined signals to the E/O converter device 42. The E/O converter device 42 converts the combined electrical signals to a light wave signal at a wavelength λ₁₁ that can be transported downstream over the optical fiber 18 to the HDT 116. In the embodiment shown in FIG. 3, the signals are transmitted over the optical fiber 18 at a wavelength λ₁₁ in the 1310 nm window.

In the DS path in the HDT 116, a signal modification device 160 that preferably comprises an O/E converter 62, an E/O converter 64, and an electrical signal combining device 161 is provided. The electrical signal combining device 161 preferably is an adder that receives cable modem signals from the CMTS 146, adds them to the cable television signals, and forwards the combined signals to the E/O converter 64. The E/O converter 64 converts the electrical signals to optical signals at a wavelength λ₁₂ where the wavelength λ₁₂ may or may not be equal to the wavelength λ₁₁. In the embodiment shown, the wavelength λ₁₂ is preferably in the 1550 nm window. After producing optical signals at the wavelength λ₁₂, the optical signals are forwarded to a fiber optic amplifier/splitter stage 66, and then to SWX 72.

Each WDM stage 76 combines the optical signals at wavelength λ₁₂ with optical signals at wavelength λ₁₃ that are generated by one of the OIUs 78 from, for example, POTS from the public network and forwards the combined multi-wavelength signals to an ONU 22 via the optical fiber 24. In the embodiment shown, the wavelength λ₁₃ is preferably in the 1310 nm window.

In the US path from the ONU 22, optical signals at a wavelength λ₁₄ are transmitted from the ONU 22 to the associated OIU 78 via a single optical fiber 24 and a single optical fiber 77. In the embodiment shown, the wavelength λ₁₄ is approximately equal to the wavelength λ₁₃, which is preferably in the 1310 nm window. The light signals at 1310 nm are able to travel in both directions on the single fiber optic cable 24 and single fiber optic cable 77. Each OIU 78 receives optical signals, converts the optical signals to electrical signals, and forwards the electrical signals to the appropriate destination. For example, POTS signals are transmitted to the public network via the public network communication path 79, the DLC 80, and the ATM network 82. STB, XM, and CM signals are forwarded by the OIUs via a plurality of copper wires 83 to the return path combiner cross-connect (RCX) 184. The RCX 184 forwards the CM signals to the CMTS 146 for further processing. The CMTS 146 can access public network communication path 79 to send any requests or data to a public network such as an IP network. Any return data from the public network can be provided to the CMTS 146 via the public network communication path 79 and the CMTS 146 can send the data to the appropriate ONU 22 via the adder 161.

The RCX 184 combines the STB and XM signals coming over the plurality of copper wires 83 from multiple OIUs 78 into one signal on one cable 85. The multiplexed signals are provided to a return path (RP) transmitter 86 that converts the RP electrical signals to RP optical signals for transmission over optical fiber 20 to the head end 14. In the embodiment shown, the RP optical signals are at a wavelength λ₁₅ wherein the wavelength λ₁₅ is preferably at a wavelength in the 1310 nm window.

In the US path in the head end 114, a return path receiver 190 preferably comprising a plurality of O/E converter devices 44 receives the RP optical signals. In the embodiment illustrated, the RP receiver includes four O/E converter devices 44 wherein each O/E converter devices 44 can receive optical signals from a separate optical fiber and convert them to electrical signals. The converted electrical signals are forwarded to the appropriate termination system, the STBTS 48, or the XMTS 50. The termination systems preferably have a high bandwidth link 52 to a Router/Switch 54 for exchanging data with a public network such as an IP network. The high bandwidth link 52 in the example of FIG. 3 is a 100 Bt Ethernet link, however, other communication links could be used such as a Gigabit Ethernet link and others. The termination systems also preferably have a communication path 55 to the electrical signal-combining device 40 for sending signals downstream over the DS path.

Second Alternative Exemplary Embodiment

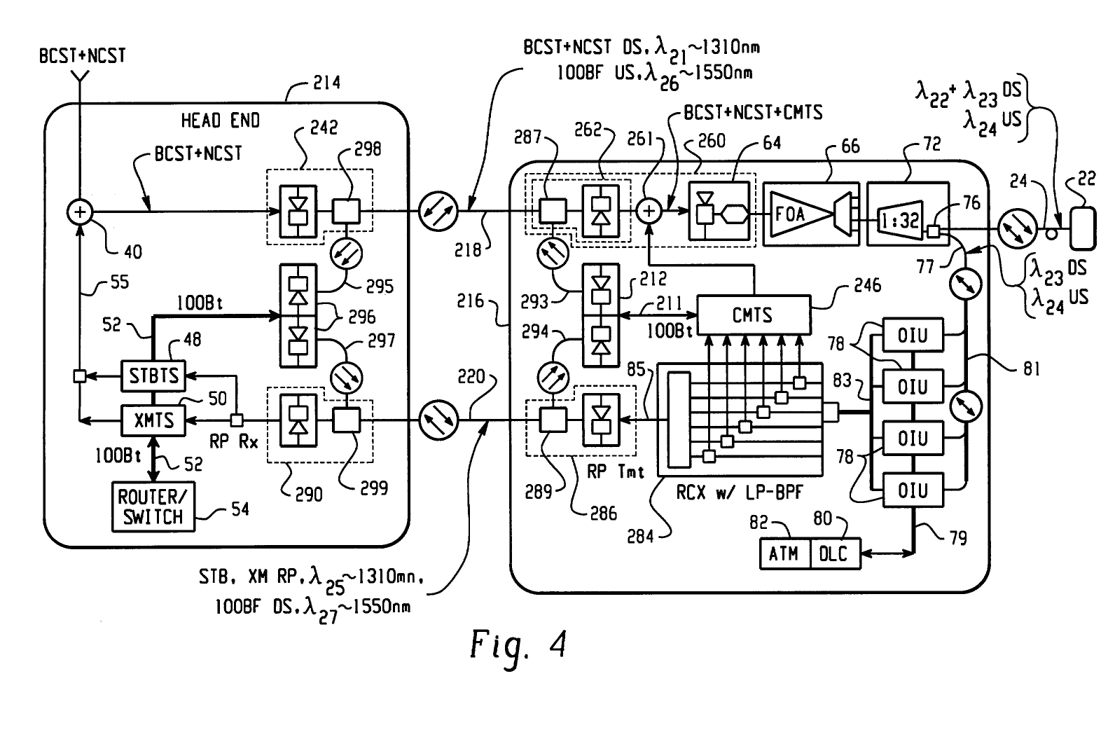

Referring now to FIG. 4, shown is a second alternative exemplary embodiment of a HFC network architecture that can provide increased cable modem bandwidth and decreased NPR degradation over the embodiment illustrated in FIG. 2. This embodiment comprises a head end 216 and a HDT 218. The head end 216 shown is similar to the head end 16 of FIG. 2 and has many elements that are comparable to the elements of the head end 16. The HDT 218 is similar to the HDT 18 of FIG. 2 and has many elements that are comparable to the elements of the HDT 18. The head end 216 and HDT 218, however, differ in a few ways. Also, the two fibers 218 and 220 coupling the head end 216 and HDT 218 accommodate bi-directional traffic.

To increase cable modem bandwidth and to decrease NPR degradation, the cable modem transmission system (CMTS) 246 is located in the HDT 218. Therefore each of the HDTs 218 connected to the head end 216 has its own CMTS 246 instead of sharing a common CMTS 246. Also, the cable modem bandwidth is not limited by the bandwidth limits for a particular wavelength of light.

In the DS path in the head end 214, the electrical signal combining device 40 preferably receives broadcast cable signal transmissions (BCST) and/or narrow-cast cable signal transmissions (NCST), such as pay-per-view stations, combines these cable signals, and forwards the combined signals to the E/O converter device 242. The E/O converter device 242 converts the combined electrical signals to a light wave signal at a wavelength λ₂₁ that can be transported downstream over the optical fiber 218 to the HDT 216. In the embodiment shown in FIG. 4, the signals are transmitted over the optical fiber 218 at a wavelength λ₂₁ in the 1310 nm window.

In the DS path in the HDT 216, a signal modification device 260 that preferably comprises an O/E converter 262, an E/O converter 64, and an electrical signal combining device 261 is provided. The electrical signal combining device 261 preferably is an adder that receives cable modem signals from the CMTS 246, adds them to the cable television signals, and forwards the combined signals to the E/O converter 64. The E/O converter 64 converts the electrical signals to optical signals at a wavelength λ₂₂ where the wavelength λ₂₂ may or may not be equal to the wavelength λ₂₁ In the embodiment shown, the wavelength λ₂₂ is preferably in the 1550 nm window. After producing optical signals at the wavelength λ₂₂, the optical signals are forwarded to a fiber optic amplifier/splitter stage 66 and then to a SWX 72.

Each WDM stage 76 combines the optical signals at wavelength λ₂₂ with optical signals at wavelength λ₂₃ that are generated by one of the OIUs 78 from, for example, POTS from the public network and forwards the combined multi-wavelength signals to an ONU 22 via the optical fiber 24. In the embodiment shown, the wavelength λ₂₃ is preferably in the 1310 nm window.

In the US path from the ONU 22, optical signals at a wavelength λ₂₄ are transmitted from the ONU 22 to the associated OIU 78 via a single optical fiber 24 and a single optical fiber 77. In the embodiment shown, the wavelength λ₂₄ is approximately equal to the wavelength λ₂₃, which is preferably in the 1310 nm window. The light signals in the 1310 nm window are able to travel in both directions on the single fiber optic cable 24 and single fiber optic cable 77. Each OIU 78 receives optical signals, converts the optical signals to electrical signals, and forwards the electrical signals to the appropriate destination. For example, POTS signals are transmitted to the public network via the public network communication path 79, the DLC 80, and the ATM network 82. STB, XM, and CM signals are forwarded by the OIUs via a plurality of copper wires 83 to the return path combiner cross-connect (RCX) 284. The RCX 284 forwards the CM signals to the CMTS 246 for further processing. The CMTS 246 can access a public network via a route to be described below to send any requests or data to a public network such as an IP network. Any return data from the public network can be provided to the CMTS 246 in accordance with the route to be described below and the CMTS 246 can send the data to the appropriate ONU 22 via the adder 261.

The RCX 284 combines the STB and XM signals coming over the plurality of copper wires 83 from multiple OIUs 78 into one signal on one cable 85. The multiplexed signals are provided to a return path (RP) transmitter 286 that converts the RP electrical signals to RP optical signals for transmission over optical fiber 220 to the head end 214. In the embodiment shown, the RP optical signals are at a wavelength λ₂₅ wherein the wavelength λ₂₅ is preferably at a wavelength in the 1310 nm window.

In the US path in the head end 214, a return path receiver 290 preferably comprising an O/E converter device receives the RP optical signals and converts them to electrical signals. The converted electrical signals are forwarded to the appropriate termination system, the STBTS 48, or the XMTS 50. The termination systems preferably have a high bandwidth link 52 to a Router/Switch 54 for exchanging data with a public network such as an IP network. The high bandwidth link 52 in the example of FIG. 4 is a 100 Bt Ethernet link, however, other communication links could be used such as a Gigabit Ethernet link and others. The termination systems also preferably have a communication path 55 to the electrical signal-combining device 40 for sending signals downstream over the DS path.

To access the public network, the CMTS 246 in this embodiment utilizes the optical fibers 218 and 220 and the router/switch 54 associated with the head end 214. In the HDT 216, the CMTS 246 is provided with a high bandwidth electrical communication path 291 to an optical transceiver 292. In this embodiment, the high bandwidth electrical communication path 291 is a 100 Bt Ethernet path (although other types of paths could be used such as Gigabit Ethernet). The optical transceiver 292 comprises a laser diode for converting 100 Bt electrical signals from the CMTS 246 into 100 Bf optical signals that are transmitted via an optical fiber 293 to an optical coupler 287 within the O/E converter 262. The 100 Bf optical signals are transmitted via the optical fiber 218 upstream to the head end 214 at a wavelength λ₂₆ that is different from the wavelength λ₂₁ of the downstream optical signals on the optical fiber 218. In this embodiment, the upstream 100 Bf optical signals are at a wavelength λ₂₆ in the 1550 nm window. The upstream 100 Bf optical signals are then forwarded via an optical fiber 295 to a transceiver 296 in the head end 214 where they are converted to 100 Bt electrical signals and forwarded to the high bandwidth link 52 to the Router/Switch 54 for exchanging data with a public network.

Data returned from the public network is received via the Router/Switch 54 and the high bandwidth link 52 and forwarded to the transceiver 296 where the 100 Bt electrical signals are converted to optical signals by an E/O converter at a wavelength λ₂₇ that preferably is in the 1550 nm window. The transceiver 296 forwards the 100 Bf optical signals via an optical fiber 297 to an optical coupler 299 and onto the optical fiber 220. The 100 Bf DS data is received at the optical coupler 286, and forwarded via an optical fiber 289 to the transceiver 292. The O/E receiver in the transceiver 292 converts the optical signals to electrical signals and forwards the returned 100 Bt data to the CMTS 246 via the high bandwidth electrical communication path 291 for further processing. The CMTS 146 can provide any returned data from the public network to the appropriate ONU 22 via the adder 261. The high bandwidth electrical communication path 291 in this example is a 100 Bt Ethernet link, however, other communication links could be used such as a Gigabit Ethernet link and others.

Third Alternative Exemplary Embodiment

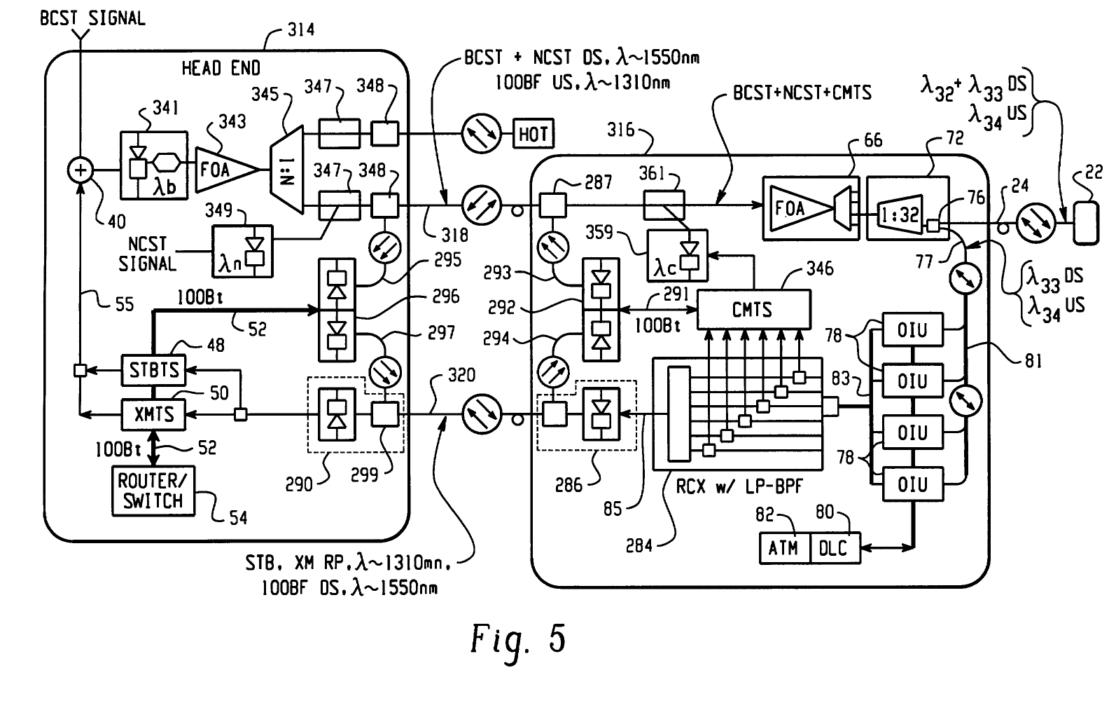

Referring now to FIG. 5, shown is a third alternative exemplary embodiment of a HFC network architecture that can provide increased cable modem bandwidth and decreased NPR degradation over the embodiment illustrated in FIG. 2. This embodiment is similar to the embodiment illustrated in FIG. 4. Instead of combining electrical signal types for transmission in the downstream path, this embodiment combines light signals using wave division multiplexing to transport the signals from multiple signal sources downstream on the optical fibers. This embodiment comprises a head end 316 and a HDT 318. The head end 316 shown is similar to the head end 216 of FIG. 4 and has many elements that are comparable to the elements of the head end 216. The HDT 318 is similar to the HDT 218 of FIG. 4 and has many elements that are comparable to the elements of the HDT 218. The head end 316 and HDT 318, however, differ in a few ways. The two fibers 318 and 320 coupling the head end 316 and HDT 318 also accommodate bi-directional traffic.

In the DS path in the head end 314, the electrical signal combining device 40 preferably receives broadcast cable signal transmissions (BCST) and sends these signals to an E/O converter 341 which converts the electrical signals to optical signals at a wavelength λ_{b}. The optical signals at wavelength λ_{b} are forwarded to a FOA 343 that amplifies the optical signals and forwards them to a 1:N splitter 345. Each output of the 1:N splitter 345 forwards the optical signals to a WDM 347 that multiplexes the signals with an optical NCST signal of wavelength λₙ. The electrical NCST signals are converted from electrical signals to optical signals by the E/O converter 349. The output of the WDM 347 is forwarded to an optical coupler 298 and transmitted over an optical fiber 318. In the illustrated embodiment, the wavelengths λ_{b} and λₙ. are centered around a wavelength λ₃₁ in the 1550 nm window.

In the DS path in the HDT 316, an optical signal combining device 361, such as a WDM, receives optical cable modem signals at a wavelength λ_{c} from the CMTS 346, adds them to the cable television signals, and forwards the combined signals to the fiber optic amplifier/splitter stage 66, and then to a SWX 72. In the embodiment shown, the wavelengths λ_{b}, λₙ and λ_{c} are centered around a wavelength λ₃₂ in the 1550 nm window.

Each WDM stage 76 combines the optical signals at wavelength λ₃₂ with optical signals at wavelength λ₃₃ that are generated by one of the OIUs 78 from, for example, POTS from the public network and forwards the combined multi-wavelength signals to an ONU 22 via the optical fiber 24. In the embodiment shown, the wavelength λ₃₃ is preferably in the 1310 nm window.

In the US path from the ONU 22, optical signals at a wavelength λ₃₄ are transmitted from the ONU 22 to the associated OIU 78 via a single optical fiber 24 and a single optical fiber 77. In the embodiment shown, the wavelength λ₃₄ is approximately equal to the wavelength λ₃₃, which is preferably in the 1310 nm window. The light signals in the 1310 nm window are able to travel in both directions on the single fiber optic cable 24 and single fiber optic cable 77. Each OIU 78 receives optical signals, converts the optical signals to electrical signals, and forwards the electrical signals to the appropriate destination. For example, POTS signals are transmitted to the public network via the public network communication path 79, the DLC 80, and the ATM network 82. STB, XM, and CM signals are forwarded by the OIUs via a plurality of copper wires 83 to the return path combiner cross-connect (RCX) 284. The RCX 284 forwards the CM signals to the CMTS 346 for further processing. The CMTS 346 can access a public network via a route similar to that described with reference to FIG. 4 above to send any requests or data to a public network such as an IP network. Any return data from the public network can be provided to the CMTS 346 in accordance with the route described above with reference to FIG. 4, and the CMTS 346 can send the data to the appropriate ONU 22 via a E/O converter 359 and the optical signal combining device 361.

The RCX 284 combines the STB and XM signals coming over the plurality of copper wires 83 from multiple OIUs 78 into one signal on one cable 85. The multiplexed signals are provided to a return path (RP) transmitter 286 that converts the RP electrical signals to RP optical signals for transmission over optical fiber 320 to the head end 314. In the embodiment shown, the RP optical signals are at a wavelength λ₃₅ wherein the wavelength λ₃₅ is preferably at a wavelength in the 1310 nm window.

In the US path in the head end 314, a return path receiver 290 preferably comprising an O/E converter device receives the RP optical signals and converts them to electrical signals. The converted electrical signals are forwarded to the appropriate termination system, such as the STBTS 48, or the XMTS 50. The termination systems preferably have a high bandwidth link 52 to a Router/Switch 54 for exchanging data with a public network such as an IP network. The high bandwidth link 52 in the example of FIG. 5 is a 100 Bt Ethernet link, however, other communication links could be used such as a Gigabit Ethernet link and others. The termination systems also preferably have a communication path 55 to the electrical signal-combining device 40 for sending signals downstream over the DS path.

Fourth Alternative Exemplary Embodiment

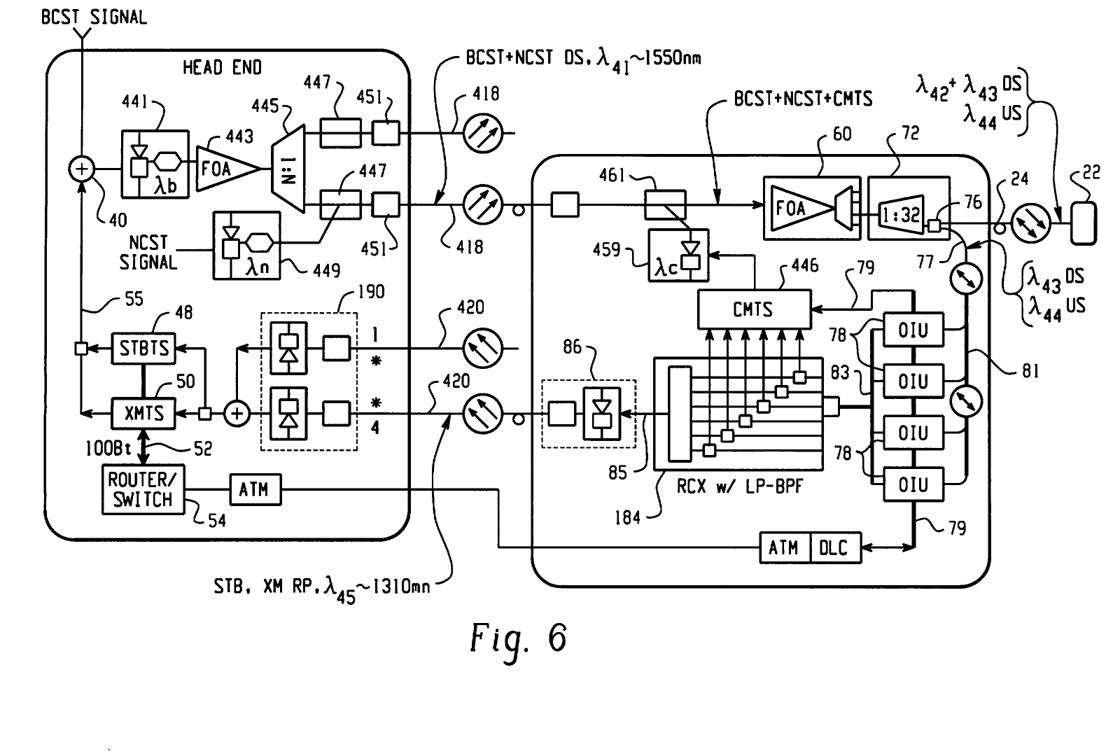

Referring now to FIG. 6, shown is a fourth alternative exemplary embodiment of a HFC network architecture that can provide increased cable modem bandwidth and decreased NPR degradation over the embodiment illustrated in FIG. 2. This embodiment is similar to the embodiment illustrated in FIG. 3. Instead of combining electrical signal types for transmission in the downstream path, this embodiment combines light signals using wave division multiplexing to transport the signals from multiple signal sources downstream on the optical fibers. This embodiment comprises a head end 416 and a HDT 418. The head end 416 shown is similar to the head end 116 of FIG. 3 and has many elements that are comparable to the elements of the head end 116. The HDT 418 is similar to the HDT 118 of FIG. 3 and has many elements that are comparable to the elements of the HDT 118. The head end 416 and HDT 418, however, differ in a few ways.

In the DS path in the head end 414, the electrical signal combining device 40 preferably receives broadcast cable signal transmissions (BCST) and sends these signals to an E/O converter 441 which converts the electrical signals to optical signals at a wavelength λ_{b}. The optical signals at wavelength λ_{b} are forwarded to a FOA 443 that amplifies the optical signals and forwards them to a 1:N splitter 445. Each output of the 1:N splitter 445 forwards the optical signals to a WDM 447 that multiplexes the signals with optical NCST signal of wavelength λₙ. The electrical NCST signals are converted from electrical signals to optical signals by the E/O converter 449. The output of the WDM 347 is forwarded to an optical coupler 451 and transmitted over an optical fiber 418. In the illustrated embodiment, the wavelengths λ_{b} and λₙ are centered around a wavelength λ₄₁ in the 1550 nm window.

In the DS path in the HDT 416, an optical signal combining device 461, such as a WDM, receives optical cable modem signals at a wavelength λ_{c} from the CMTS 446, adds them to the cable television signals, and forwards the combined signals to the fiber optic amplifier/splitter stage 66, and then to a SWX 72. In the embodiment shown, the wavelengths λ_{b}, λₙ and λ_{c} are centered around a wavelength λ₄₂ in the 1550 nm window.

Each WDM stage 76 combines the optical signals at wavelength λ₄₂ with optical signals at wavelength λ₄₃ that are generated by one of the OIUs 78 from, for example, POTS from the public network and forwards the combined multi-wavelength signals to an ONU 22 via the optical fiber 24. In the embodiment shown, the wavelength λ₄₃ is preferably in the 1310 nm window.

In the US path from the ONU 22, optical signals at a wavelength λ₄₄ are transmitted from the ONU 22 to the associated OIU 78 via a single optical fiber 24 and a single optical fiber 77. In the embodiment shown, the wavelength λ₄₄ is approximately equal to the wavelength λ₄₃, which is preferably in the 1310 nm window. The light signals in the 1310 nm window are able to travel in both directions on the single fiber optic cable 24 and single fiber optic cable 77. Each OIU 78 receives optical signals, converts the optical signals to electrical signals, and forwards the electrical signals to the appropriate destination. For example, POTS signals are transmitted to the public network via the public network communication path 79, the DLC 80, and the ATM network 82. STB, XM, and CM signals are forwarded by the OIUs via a plurality of copper wires 83 to the return path combiner cross-connect (RCX) 184. The RCX 284 forwards the CM signals to the CMTS 446 for further processing. The CMTS 446 can access a public network via a route similar to that described with reference to FIG. 3 above to send any requests or data to a public network such as an IP network. Any return data from the public network can be provided to the CMTS 446 in accordance with the route described above with reference to FIG. 3, and the CMTS 446 can send the data to the appropriate ONU 22 via a E/O converter 459 and the optical signal combining device 461.

The RCX 184 combines the STB and XM signals coming over the plurality of copper wires 83 from multiple OIUs 78 into one signal on one cable 85. The multiplexed signals are provided to a return path (RP) transmitter 86 that converts the RP electrical signals to RP optical signals for transmission over optical fiber 420 to the head end 414. In the embodiment shown, the RP optical signals are at a wavelength λ₄₅ wherein the wavelength λ₄₅ is preferably at a wavelength in the 1310 nm window.

In the US path in the head end 414, a return path receiver 190 preferably comprising an O/E converter device receives the RP optical signals and converts them to electrical signals. The converted electrical signals are forwarded to the appropriate termination system, such as the STBTS 48, or the XMTS 50. The termination systems preferably have a high bandwidth link 52 to a Router/Switch 54 for exchanging data with a public network such as an IP network. The high bandwidth link 52 in the example of FIG. 6 is a 100 Bt Ethernet link, however, other communication links could be used such as a Gigabit Ethernet link and others. The termination systems also preferably have a communication path 55 to the electrical signal-combining device 40 for sending signals downstream over the DS path.

Conclusion

Other variations from these systems and methods should become apparent to one of ordinary skill in the art without departing from the scope of the invention defined by the claims. The preferred embodiments have been described with reference to FTTC HFC systems but the invention described by the claims could be applicable to other network systems.

The embodiments described herein and shown in the drawings are examples of structures, systems or methods having elements corresponding to the elements of the invention recited in the claims. This written description and drawings may enable those skilled in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences from the literal language of the claims. It is also to be understood that the invention is not limited to use with FTTC systems unless explicitly limited by the claims.

The following is claimed:

1. A communication system for transmitting video signals to a subscriber using optical fibers, for providing bi-directional telephone services for a subscriber using optical fibers, and for providing high speed data services to a subscriber via a cable modem using optical fibers, the communication system comprising:
a first optical fiber for transporting video programming at a first wavelength from a video programming source to a network node;
a second optical fiber for transporting video programming at a second wavelength from the network node to an optical node device and for transporting bi-directional telephone signals between the optical node device and the network node at a third wavelength in a downstream direction and a fourth wavelength in an upstream direction;
a signal combining device located at the network node that combines cable modem (CM) signals from a cable modem transmission system (CMTS) located at the network node with the video programming prior to the transportation of the video programming on the second optical fiber; and
a high bandwidth bi-directional communication path between the CMTS and a public network.

2. The system of claim 1 wherein the optical node device is an optical network unit (ONU).

3. The system of claim 1 wherein the communication system is a fiber-to-the-curb (FTTC) system.

4. The system of claim 1 wherein the network node comprises a point-of-presence (POP) in a central office (CO).

5. The system of claim 1 wherein the network node comprises a host digital terminal (HDT).

6. The system of claim 5 wherein the HDT is located at a central office (CO).

7. The system of claim 1 wherein video programming comprises cable television programming.

8. The system of claim 7 wherein the cable television programming comprises broadcast cable television programming.

9. The system of claim 7 wherein the cable television programming comprises pay-per-view cable television programming.

10. The system of claim 7 wherein the cable television programming comprises narrow-cast cable television programming.

11. The system of claim 1 wherein video programming comprises cable modem signals.

12. The system of claim 1 wherein the television programming source is a cable head-end.

13. The system of claim 1 wherein the first wavelength is in the 1310 nano-meter (nm) window, and the second wavelength is in the 1550 nm window.

14. The system of claim 1 wherein the first wavelength is in the 1550 nm window, and the second wavelength is in the 1550 nm window.

15. The system of claim 1 wherein the first wavelength is in the 1310 nano-meter (nm) window, and the second wavelength is in the 1310 nm window.

16. The system of claim 1 wherein the first wavelength is in the 1550 nm window, and the second wavelength is in the 1310 nm window.

17. The system of claim 1 wherein the third wavelength is approximately equal to the fourth wavelength.

18. The system of claim 17 wherein the second wavelength is different from the third and fourth wavelengths.

19. The system of claim 18 wherein the third and fourth wavelengths are in the 1310 nm window and the second wavelength is in the 1550 nm window.

20. The system of claim 18 wherein the third and fourth wavelengths are in the 1550 nm window and the second wavelength is in the 1310 nm window.

21. The system of claim 1 wherein the signal combining device is an electrical signal-combining device.

22. The system of claim 21 wherein the electrical signal combining device is an adder.

23. The system of claim 1 wherein the signal combining device is an optical signal-combining device.

24. The system of claim 23 wherein the optical signal combining device is a wavelength division-multiplexing device.

25. The system of claim 1 wherein the high bandwidth bi-directional communication path transports CM signals from the CMTS to the public network via a public network communication path associated with the digital terminal equipment, and wherein the high bandwidth bi-directional communication path transports CM data from the public network to the CMTS via the public network communication path associated with the digital terminal equipment.

26. The system of claim 1 wherein the high bandwidth bi-directional communication path transports CM signals from the CMTS to the public network via the first optical fiber in an upstream direction at a sixth wavelength and via a high bandwidth link associated with the television programming source.

27. The system of claim 26 wherein the high bandwidth bi-directional communication path transports CM data to the CMTS from the public network via the high bandwidth link associated with the television programming source and via a third optical fiber in a downstream direction.

28. The system of claim 1 wherein the high bandwidth bi-directional communication path is a 100 Megabit path.

29. The system of claim 1 wherein the high bandwidth bi-directional communication path is a Gigabit path.
